(19) United States
(12) Patent Application Publication
(10) Pub. No.: US 2026/0099019 A1
(43) Pub. Date: Apr. 9, 2026

(54) COMPLIANT PROCESS FOR HIGH-LEVEL PLANAR ASSEMBLY

(71) Applicant: International Business Machines Corporation, Armonk, NY (US)

(72) Inventors: Paul Gond-Charton, Granby (CA); Steve Pellerin, Bromont (CA); Sebastien Gouin, Bromont (CA); Elaine Cyr, Granby (CA); Patrick Jacques, St-Hubert (CA)

(21) Appl. No.: 19/094,946

(22) Filed: Mar. 30, 2025

Related U.S. Application Data
(60) Provisional application No. 63/704,522, filed on Oct. 7, 2024.

(51) Int. Cl. G02B 6/42; G02B 6/36

(52) U.S. Cl. CPC G02B 6/4228; G02B 6/362; G02B 6/3636; G02B 6/3664; G02B 6/4242

(57) ABSTRACT

To assemble a donor part to a receiver part, place the receiver part on a stage; provide at least one compliant elastomeric member associated with at least one of the stage and a vacuum element; and use the vacuum element to lift the donor part and assemble it to the receiver part on the stage. Misalignment of the receiver part and the donor part is tolerated by the at least one compliant elastomeric member.

### CROSS-REFERENCE TO RELATED APPLICATIONS

This application claims the benefit of U.S. Provisional Patent Application No. 63/704,522 filed on Oct. 7, 2024, the complete disclosure of which is expressly incorporated by reference herein in its entirety for all purposes.

### BACKGROUND

The present invention relates generally to the electro-optical and mechanical arts, and, more particularly, to assembling optical fibers and the like to photonic dies and the like.

In the microelectronic packaging domain, and especially in photonic packaging, high level alignment precision is required. For example, for an efficient fiber-to-die coupling, a misalignment tolerance below 1 μm is necessary to avoid signal losses and to meet telecommunication specifications.

Requirements for precise alignment have a negative impact on cycle time and profitability, slowing down the global implementation of light interconnections into consumer market devices. Keeping this alignment during the subsequent process steps is also desirable.

### BRIEF SUMMARY

Principles of the invention provide techniques for compliant high-level planar assembly. In one aspect, an exemplary method of assembling a donor part to a receiver part includes: placing the receiver part on a stage; providing at least one compliant elastomeric member associated with at least one of the stage and a vacuum element; and using the vacuum element to lift the donor part and assemble it to the receiver part on the stage; where misalignment of the receiver part and the donor part is tolerated by the at least one compliant elastomeric member.

In another aspect, an exemplary assembly includes a donor part; a receiver part; a stage supporting the receiver part; a vacuum element movable with respect to the stage; and at least one compliant elastomeric member associated with at least one of the stage and the vacuum element. The donor part is secured to the vacuum element by vacuum and is located adjacent the receiver part, and misalignment of the receiver part and the donor part is tolerated by the at least one compliant elastomeric member.

A further aspect includes a donor part and a receiver part assembled using techniques in accordance with aspects of the invention.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor and/or by fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
reduction of the process cycle time while keeping a process which meets the tight alignment specifications;
simple and robust, cost-effective solution;
high performance processes with high yield/low defects;
reduction of downtime and setup time on assembly equipment.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1 and 2 depict elastomeric materials embedded into tooling to allow compliance in accordance with an aspect of the invention;

FIG. 3 shows parallelized fiber assembly in accordance with aspects of the invention;

FIG. 4 shows compliant polymer interface assembly in accordance with aspects of the invention;

FIGS. 5 and 6 show an exemplary elastomeric suction member in accordance with aspects of the invention;

FIG. 7 shows a stage with an elastomeric member in accordance with aspects of the invention;

FIGS. 8 and 9 compare insertion loss for prior art and exemplary aspects of the invention;

FIGS. 10 and 11 show additional aspects of parallelized fiber assembly in accordance with aspects of the invention;

FIGS. 12 and 13 show additional aspects of compliant polymer interface assembly in accordance with aspects of the invention;

FIGS. 14 and 15 show aspects of laser die assembly in accordance with aspects of the invention;

FIGS. 16 and 17 show another exemplary elastomeric suction member in accordance with aspects of the invention; and

FIG. 18 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

One or more embodiments advantageously adapt and improve packaging concepts to photonic packaging, and provide novel; elastomeric member(s). One pertinent benefit is the reduction of the process cycle time while keeping a process which meets the tight alignment specifications. One or more embodiments advantageously employ part(s) with elastomeric compliance to tolerate misalignment in photonic packaging.

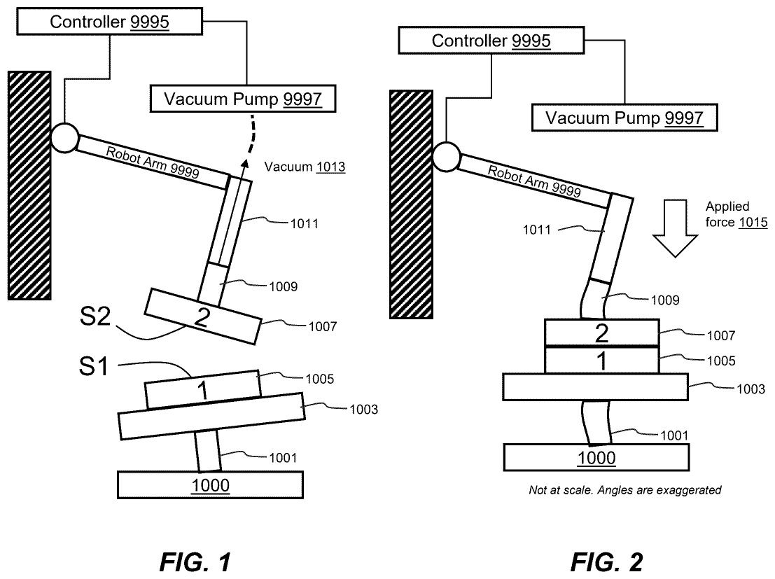

Referring to FIGS. 1 and 2, one or more embodiments advantageously employ elastomeric materials embedded into the tooling to allow compliance during a force application step as shown in FIG. 2. In FIG. 1, note the receiver part side 1005 on stage 1003 and the donor part side 1007 picked up with a vacuum pick tip. In the example of FIG. 1, stage 1003 is supported by a member 1001 of compliant elastomeric material, while donor side 1007 is picked up by hollow tip 1009, formed from compliant elastomeric material, in communication with vacuum tube 1011 to which vacuum 1013 is applied. As such, the hollow tip 1009 may also be referred to herein as a ‘vacuum tip,’ ‘elastomeric tip,’ ‘pick-tip’/‘tip,’ etc. The word “elastomer” is used herein in its normal sense; namely, an amorphous polymer showing high resistance to large deformations. The Young's modulus of this kind of material is on the order of magnitude of megapascals (MPa) with reversible extensibility.

Use of elements 1001 and/or 1009 of elastomeric material advantageously creates parallelism between the donor side 1007 and the receiver side 1005 to enhance alignment accuracy. One or more embodiments are suitable, for example, for photonic applications. In a non-limiting example, on the donor side there are v-grooves inside a silicon die for containing circular optical fibers. The donor side (e.g., glass lid) is compressed on top of the fibers, and parallelism of the lid is quite pertinent.

Elastomeric elements can be applied on the receiver side, as seen at 1001, supporting the stage 1003 where the module is assembled above fixed support 1000, and/or on the donor side, as seen at 1009 (part of the pick-tip assembly which brings the donor part 1007 to be bonded). In one or more embodiments, elastic deformation of the elastomeric part of the pick-tip 1009 and/or elastomeric element 1001 provides the amount of deformation required to reach the parallelism between surface S1 and surface S2 as appropriate for the assembly.

In one or more embodiments, deformation of the elastomeric elements 1001, 1009 is reversible, advantageously avoiding the need for a change of the tooling between each processed part(s).

In a non-limiting example, receiver side 1005 includes an optoelectronic component. An elastomeric element 1001 supports stage 1003, element 1001 need not be hollow (but can be if desired). In a non-limiting example, donor side 1007 is a lid such as a glass or polymer lid. Vacuum tube 1011 with hollow (to apply vacuum to the part 1007) elastomeric tip 1009 picks up the lid.

FIG. 2 shows the system of FIG. 1 after force 1015 is applied in the direction shown. Force can be applied, for example, by moving the tip 1009 towards the fixed stage 1003, moving the stage 1003 towards the (fixed) tip 1009, or moving the tip 1009 and stage 1003 towards each other. Misalignment can be tolerated, as seen in FIG. 2, due to compliance in the elastomeric elements 1009 and/or 1001 (the angles are exaggerated for clarity).

In FIGS. 1 and 2, note the robot arm 9999, vacuum pump 9997, and controller 9995. Controller 9995 can be implemented, for example, with a general purpose computer as discussed below, but could also be implemented with a field-programmable gate array (FPGA), application-specific integrated circuit, or the like. Controller 9995 signals vacuum pump 9997 when to begin/stop applying vacuum 1013 to tube 1011. Controller 9995 also signals robot arm 9999 to pick up donor side 1007 (e.g., using vacuum to hold it in place), to align the donor side 1007 with the receiver side 1005, to press down to apply force, and the like.

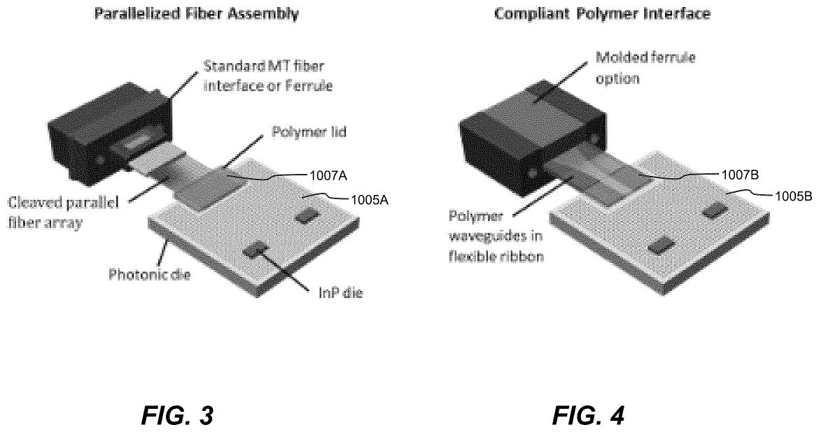

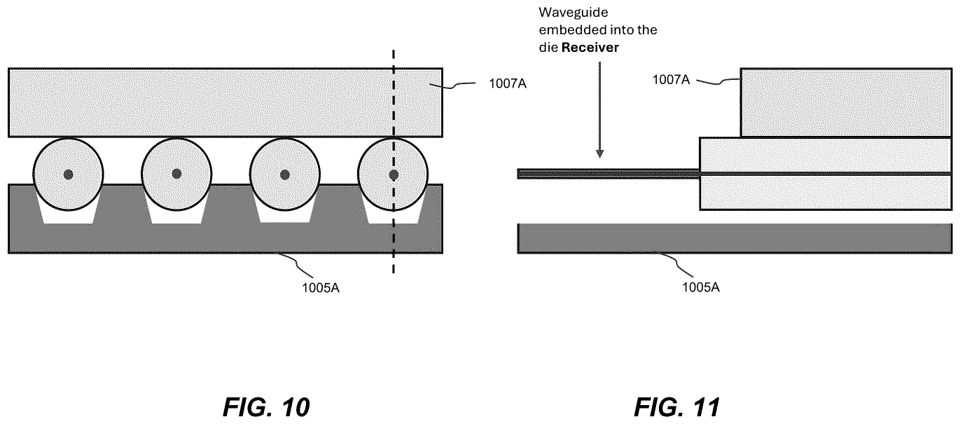

A number of different use cases are possible. A fiber attach process, as shown in the parallelized fiber assembly view of FIG. 3, is carried out to ensure well-seated fibers into V-grooves, thanks to high parallelism of a glass (or polymer) lid with the die surface. Note the standard MT connector (a multifiber connector that houses up to 72 fibers in a single ferrule), the cleaved parallel fiber array (i.e., fiber cores and few millimeters of bare fiber cladding exposed), the polymer lid 1007A, the photonic die 1005A, and the InP laser die. Refer also to FIGS. 10 and 11; note elements 1005A (receiver such as silicon die with embedded V-grooves), 1007A (donor such as glass or polymer lid) and the optical fibers with cladding and cores located in the V-grooves. The exposed fiber core can be seen in FIG. 11

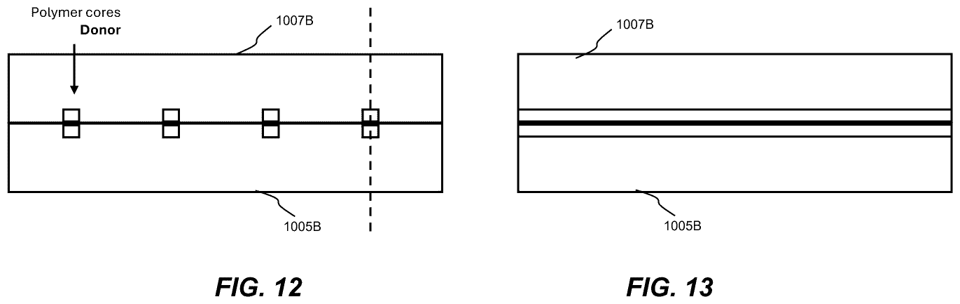

A polymer attach process, as shown in FIGS. 4, 12, and 13 is carried out to ensure low loss optical coupling, thanks to high parallelism of the polymer flex with the die. In FIG. 4, note the molded ferrule, the polymer waveguides in a flexible sheet—the donor 1007B is a polymer with embedded cores, the photonic die 1005B, and the InP laser die. In the compliant polymer interface, parallelism is still needed between the flex polymer and the waveguides on the photonic die. Here, light is coupled through the top surface instead of the edge of the die. In FIGS. 12 and 13, note the polymer with embedded cores (donor) 1007B, polymer cores, and silicon die with embedded waveguides (receiver) 1005B.

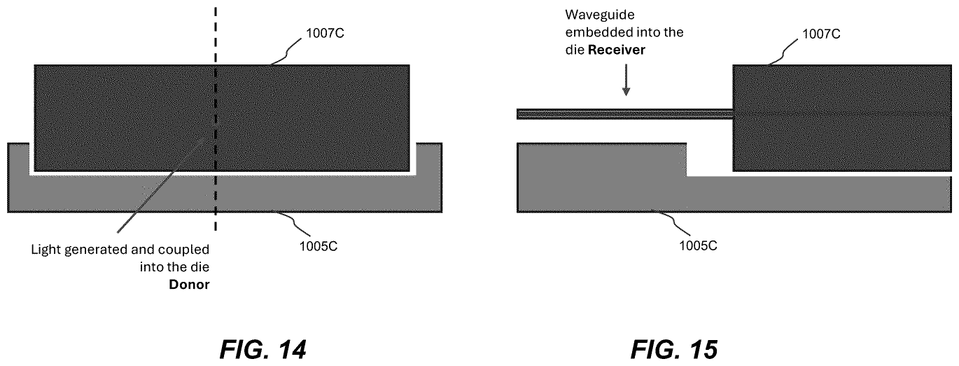

A laser attach process, as shown in FIGS. 14 and 15, ensures optimal alignment between an InP (or other) laser spot and waveguides embedded into the photonic dies, thanks to high parallelism of the InP die's surface with the photonic die surface. It is desired to ensure alignment between the indium phosphide (InP) laser and waveguides in the photonics dies. Again, parallelism is important. Note the Indium Phosphide laser die (donor) 1007C, silicon die with embedded cavity (receiver) 1005C, and the light generated and coupled into the die.

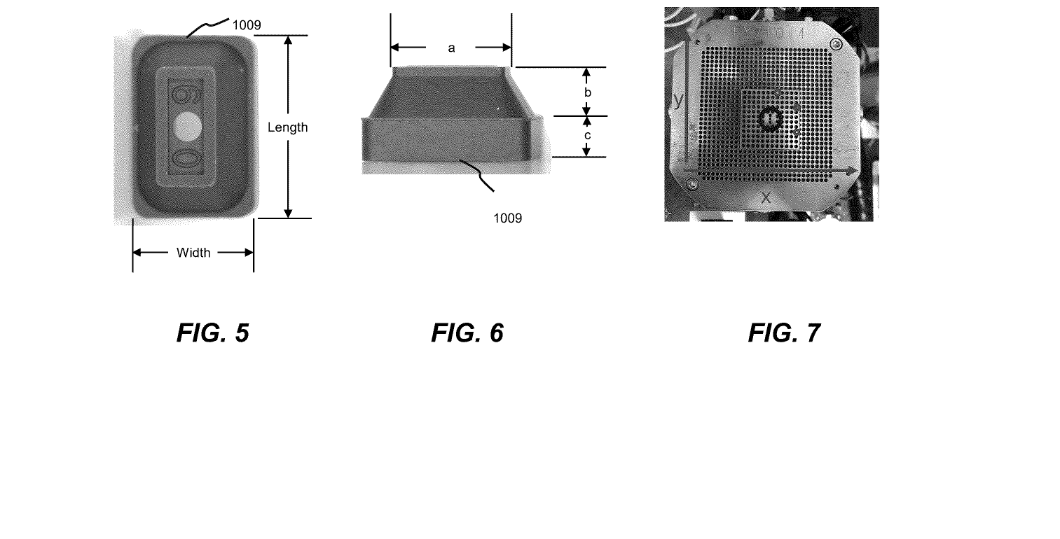

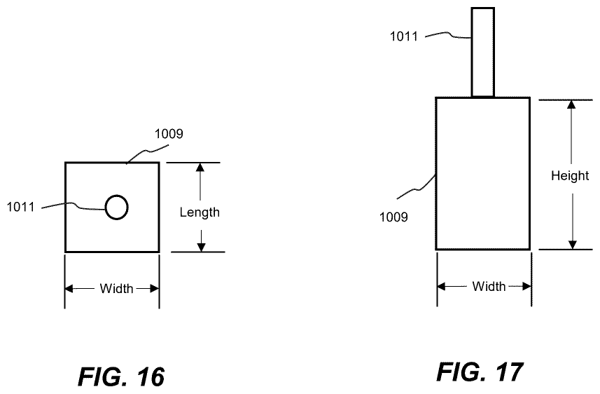

FIGS. 5 and 6 show aspects of an exemplary suction cup used for pick-tip 1009. This element advantageously allows pick and place of a glass or polymer lid (FIG. 3), polymer flex (FIG. 4), or InP (or other) dies (FIGS. 14 and 15) combined with the desired compliancy. In a non-limiting example, tip 1009 is made from an elastomer with a Young's modulus of 4 MPa. Non-limiting exemplary dimensions for the contact surface, as seen in FIG. 5, include: Length 6 mm, Width 4 mm, a=4 mm, b=1.8 mm and c=1.5 mm. FIGS. 16 and 17 show aspects (respectively top view and side view) of another exemplary suction cup used for pick-tip 1009, which is shaped like a hollow rectangular prism. In a non-limiting example, the width and length are each 1 mm and the height is 2 mm. The wall thickness in the example of FIGS. 5 and 6 and in the example of FIGS. 16 and 17 can be about 0.3 mm (depending on manufacturer availability, for example—other embodiments can use other wall thicknesses). An exemplary advantage of reducing the suction cup size to 1×1 mm width by length is to keep space for adhesive UV (ultraviolet) illumination in both sides of the suction cup. As seen in FIGS. 16 and 17, the example is taller than wide. The dimensions described with respect to FIGS. 5 and 6 and with respect to FIGS. 16 and 17 are exemplary. Generally, for example, the width and length can range from 0.5-10 mm, or, in some cases, from 1-6 mm.

FIG. 7 shows a stage 1003 equipped with an elastomer O-ring to allow the appropriate compliancy. In a non-limiting example, the O-ring has an inner diameter of 14 mm and an outer diameter of 15 mm, a circular cross-section, and is made from an elastomer with a Young's modulus of 4 MPa. The small holes in the stage allow for applying vacuum in a known manner. The elastomer can be between the module and the stage as in FIG. 7 or between the stage and the fixed support 1000 as in FIGS. 1 and 2, or both; either or both can be used in conjunction with element 1009 or separately, for example.

Both elastomeric elements can, but need not, be employed simultaneously.

One or more embodiments can be implemented by modifying known optical packaging equipment with the elastomeric element(s).

One or more embodiments advantageously improve upon existing techniques used to attempt to achieve parallelism. For example, in one current technique, a quartz pick-tip must be sanded to become perpendicular to the stage surface; and the stage must be mounted on a goniometer. The goniometer is adjusted according to a confocal parallelism measurement into the equipment. Two axis measurements consume about 30 seconds-5 minutes of cycle time, and the measurement is highly dependent on surface nature and pattern (highly sensitive thereto). In contrast, one or more embodiments are simple and robust, cost-effective, and decrease cycle time.

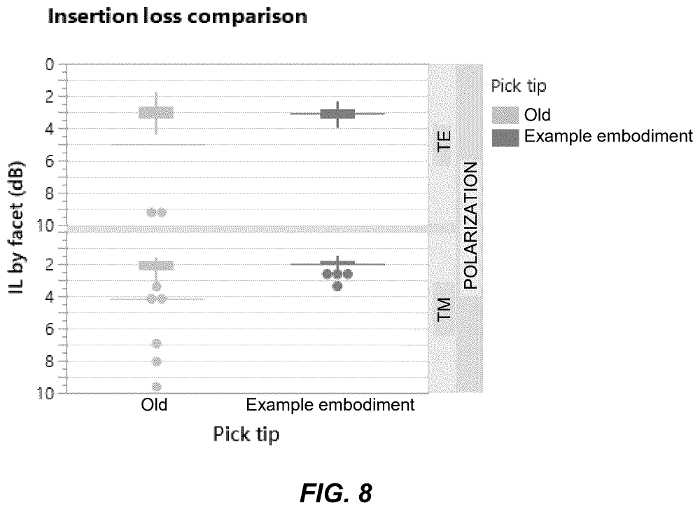

FIG. 8 compares exemplary results obtained using aspects of the invention (compliant elastomeric suction cup to control parallelism) to a conventional module assembly process using confocal measurement and goniometer adjustment.

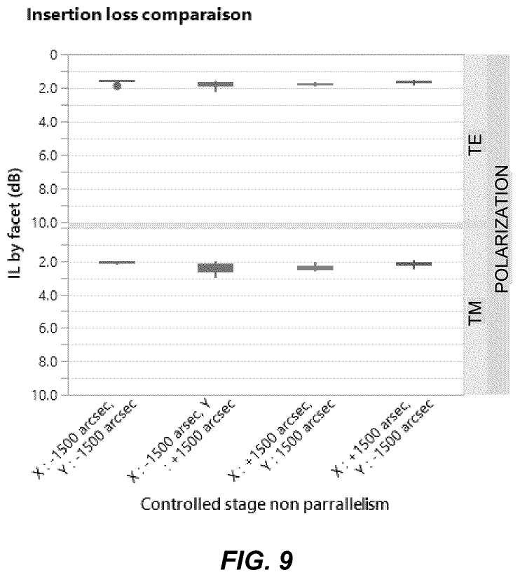

FIG. 9 demonstrates repeatability even on controlled nonplanar surfaces (forcing a non-parallelism of 1500 arc sec (about 0.4°) on the X and Y axes for test purposes). In FIGS. 8 and 9, IL=insertion loss in dB down, and it can be seen in FIG. 8 that there are points for the prior art approach with higher IL than the example inventive embodiment. TM polarization is more sensitive to misalignment so more outliers are seen.

One or more embodiments provide an apparatus comprising an elastomeric material to permit two surfaces to be pressed together with substantially uniform force by compliantly compressing the elastomeric material. One or more embodiments use elastomeric materials embedded into the tooling to allow a compliancy during an applied force recipe step as seen in FIG. 2. The elastomeric material can be applied on the receiver side 1005 (stage 1003 where the module is assembled as seen at 1001 and/or on the donor side pick-tip assembly which brings the part 1007 to be bonded as seen at 1009. In one or more embodiments, elastic deformation of the elastomeric parts 1009 of the pick-tip and/or elastomeric element 1001 provide the amount of deformation required to reach the parallelism between surface S1 and S2 needed for the assembly. Advantageously, reversibility of deformation avoids a change of the tooling between each processed part(s).

It is worth noting that some prior art devices use two elastic components in compression stacked devices, including an intermediate silicon rubber layer including electrical through vias formed with ball wires. Further, such devices may use elastic features in the fastening system allowing permanent compression of the device. In contrast, in one or more embodiments, no permanent compression is applied—compression is used only during assembly. Advantageously, in one or more embodiments, compression load during assembly is eight times less. In one or more embodiments, elastic compliant material is not included into the final device (the compliant material is part of the assembly fixture instead); rather, compliant material is used for high-level parallelism during assembly at room temperature and no CTE (coefficient of thermal expansion; e.g., between semiconductor material and polymer) mismatch concerns arise in subsequent fabrication steps (e.g., reflow processes at 230° C.). Further, in one or more embodiments, no electrical needs through the compliant material are needed.

Further, some other prior art devices use an elastomeric layer between two laminates included into a rigid probe setup. They also add some small coils/springs to help reversibility of the deformation. The goal is to adapt wafer level testing to different bump height related to process variability. In contrast, in one or more embodiments, the compliant material is not used as a layer in a stacked assembly; sub-millimeters coils are not needed; the deformability needed in one or more embodiments is at millimeter scale (e.g., top glass lid is 1.5×4 mm) to obtain high-level parallelism. In one or more embodiments, 17 μm of bump height difference can be accommodated in a range of about 250 μm. Such prior art techniques typically try to accommodate micrometer bump uniformity during wafer level testing, whereas one or more embodiments ensure high-level parallelism on a millimeter scale.

Still further, in another prior art approach, elastomeric materials are used in a wafer level rigid probe context to accommodate tilt on the wafer during wafer level test (there is no assembly, and no components are added on top of the wafer). In contrast, in one or more embodiments, the compliant material allows a tilt compensation of the glass (or polymer) lid compared to the die surface but followed by a UV curing of the pre-dispensed adhesive during the simultaneous compression of the elastomer. One or more embodiments advantageously permit at least +/−0.4° of tilt compensation in two directions and it is believed that even greater amounts of tilt can be accommodated in some embodiments. One or more embodiments relate to optical assembly with a high level of parallelism.

In still another prior art aspect, elastomeric elements are mixed into solder materials to adapt thickness differences of various devices and produce packages into tight dimensional specifications. So, packages to packages, the elastomeric elements will be deformed among a certain amount to adapt the thickness differences of die stacks. In contrast, in one or more embodiments, compliant material is not present into the final device; compliant material is not mixed to solder metal mixes; compliant material is used in one or more embodiments to accommodate tilt difference between surfaces and is not used to accommodate thickness differences; compression is performed at room temperature (and not at a reflow temperature). Indeed, the compression of the glass or polymer lid in one or more embodiments is performed at room temperature and compliancy is already active at this temperature. This allows a simpler equipment design.

In yet another prior art aspect, equipment is provided for lithography nano-imprint processes. A floating body attached to a main frame by flexible features is used to perform compliancy achieving a certain level of parallelism between the template and the wafer. This parallelism is needed to finely control the thicknesses let into the photoresist deposited on the wafer surface. In contrast, in one or more embodiments, a part can be assembled on top of another part. To accomplish this, one or more embodiments use the pick-and-place principle using a suction cup manufactured with the compliant material of interest. In one or more such prior art approaches, the level of tilt that can be accommodated is about +/−0.040° which is an order of magnitude below what can be achieved with one or more embodiments, namely, +/−0.400°. Indeed, one or more embodiments permit assembly of a part on top of another part with a high level of parallelism, allowing a finely controlled glass lid assembly on top of optical fibers seated into V-grooves present on the semiconductor die. Indeed, in one or more embodiments, a high precision alignment of +/−1.5 μm can be reached in only a few seconds.

In an even further prior art aspect, an optical device includes three laser diodes combined with wavelength filters, with no provision for assembly process details, even if the alignment and parallelism are crucial for optical performances of the device. A discrete laser diode addressed by this prior art approach is an old technology compared to what silicon photonic can integrate nowadays. In contrast, one or more embodiments focus on an assembly process allowing compliancy to achieve high-level parallelism.

In yet another prior art aspect, V-grooves and optical fibers for optoelectronic devices are addressed using one or more metal springs. In contrast, one or more embodiments, instead of using metal springs for the compliant material instead employ an elastomeric/polymer suction cup and bearing. Furthermore, in this prior art aspect, it is indicated that the tip needs to be made in a hard and stiff material (in some case similar to the top lid). One or more embodiments can be easily implemented on commercial equipment, which is believed to be more difficult for the prior art aspect. Indeed, one or more embodiments are more compatible with existing equipment for high-volume manufacturing.

An additional prior art aspect seeks to assemble optical fibers into a V-groove. This aspect focuses on tooling allowing handling of single fiber or fiber array units. This part of the prior art process is indeed very challenging especially due to small diameter and brittleness of bare fibers, and indicates a need of parallelism between the fiber array plan and the photonic integrated circuit (PIC) die plan. However, no solution to the issue seems to be offered. In contrast, one or more embodiments address the parallelism of a glass/polymer lid compressed on top of the fiber array unit and then glued thanks to UV adhesive. One or more embodiments are not necessarily addressed to the handing of the fiber array unit which is already well understood by the skilled person of the art. One or more embodiments have been proven feasible with experiments adopting a known fiber array unit handling method to achieve parallelism with elastomeric members.

Thus, one or more prior art approaches use compliancy to adjust thickness difference or tilt without assembling parts. Other approaches use spring solutions to achieve the needed high-level parallelism during optical fiber assembly. One or more embodiments use novel materials combined with the assembly of the glass/polymer lid with a high level of parallelism.

An advantage of the hollow elastomeric tip is that it provides elastomeric compliance while simply and directly applying force to the workpiece. The possibility to pick and place thanks to the vacuum and to accommodate tilts is an advantage compared to prior art solutions using metallic springs.

Pertinent properties of the elastomeric portions include Young's modulus, moment of inertia (which can be calculated from dimensions and wall thickness), materials, hardness, and the like. The Young's modulus for the elastomeric portions can range, for example, from 1 to 15 MPa; and the hardness can range from 20 Shore A durometer to 90 Shore A durometer. In experiments, we successfully tested 88, 85 and 55 Shore A. At low Young's modulus/hardness (below 1 MPa and 20 Shore A, respectively), the form factor of the suction cup can be challenging to manufacture. For the range of the compressive force 1015, a range of from 250 to 750 g (grams force) can be employed. It is believed that a value of 500 g (grams force) is desirable. Example elastomers include nitrile rubber, fluoro-elastomer and silicone rubber. It is believed that thermoplastic elastomers should also work.

The lid can be a polymer lid or a glass lid, for example. In one or more embodiments, a photonic die is on a stage assembled to ferrule and it is desired to assemble the lid on it with fibers well-seated in grooves. The glass or polymer lid is nominally planar, and V-grooves are on the stage; if the lid is not planar, the fibers will not be properly seated into the V-grooves.

Aspects of the invention can be used in connection with semiconductor device manufacturing, which includes various known manufacturing steps. Semiconductor dies can be made using these known techniques and assembled using aspects of the invention.

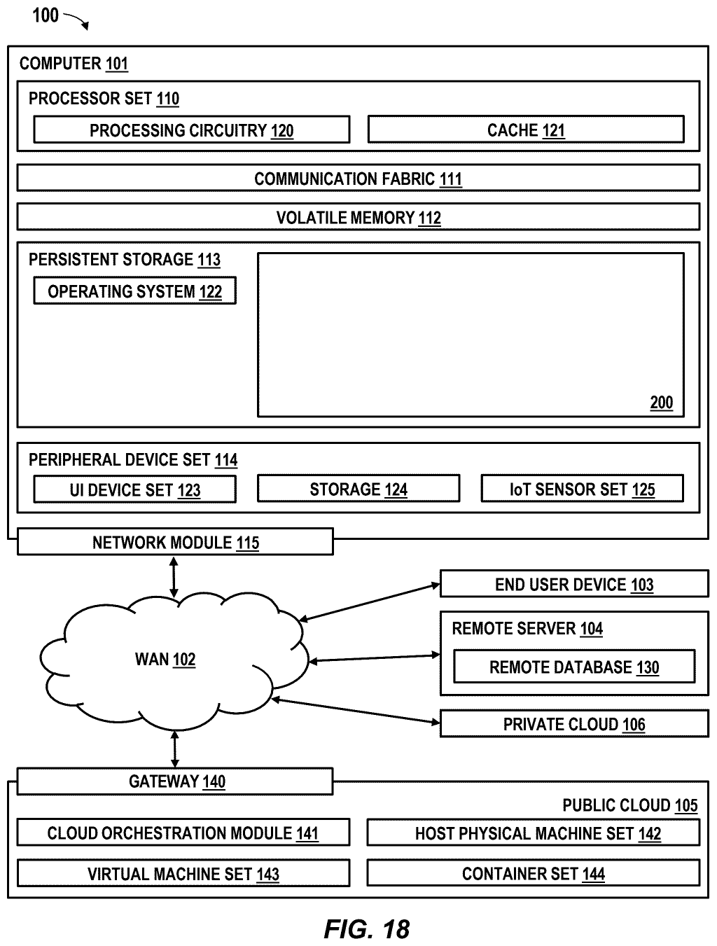

Refer now to FIG. 18.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as controlling the pick-and-place apparatus as described herein with control code 200 to implement controller 9995. Control can be, for example, over WAN 102 via network module 115 with the robot arm and vacuum pump treated as end user devices 103 (cables or wireless connections can be used instead of WAN 102 in other embodiments). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 18. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be appreciated that the various layers and/or regions shown in the accompanying figures may not be drawn to scale.

The illustrations of embodiments described herein are intended to provide a general understanding of the various embodiments, and they are not intended to serve as a complete description of all the elements and features of apparatus and systems that might make use of the circuits and techniques described herein. Many other embodiments will become apparent to those skilled in the art given the teachings herein; other embodiments are utilized and derived therefrom, such that structural and logical substitutions and changes can be made without departing from the scope of this disclosure. It should also be noted that, in some alternative implementations, some of the steps of the exemplary methods may occur out of the order noted in the figures. For example, two steps shown in succession may, in fact, be executed substantially concurrently, or certain steps may sometimes be executed in the reverse order, depending upon the functionality involved. The drawings are also merely representational and are not drawn to scale. Accordingly, the specification and drawings are to be regarded in an illustrative rather than a restrictive sense.

Embodiments are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Terms such as “bottom”, “top”, “above”, “over”, “under” and “below” are used to indicate relative positioning of elements or structures to each other as opposed to relative elevation. If a layer of a structure is described herein as “over” another layer, it will be understood that there may or may not be intermediate elements or layers between the two specified layers. If a layer is described as “directly on” another layer, direct contact of the two layers is indicated. As the term is used herein and in the appended claims, “about” means within plus or minus ten percent.

The corresponding structures, materials, acts, and equivalents of any means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit thereof. The embodiments were chosen and described in order to best explain principles and practical applications, and to enable others of ordinary skill in the art to understand the various embodiments with various modifications as are suited to the particular use contemplated.

The abstract is provided to comply with 37 C.F.R. § 1.76(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, the claimed subject matter may lie in less than all features of a single embodiment. Thus, the following claims are hereby incorporated into the Detailed Description, with each claim standing on its own as separately claimed subject matter.

Given the teachings provided herein, one of ordinary skill in the art will be able to contemplate other implementations and applications of the techniques and disclosed embodiments. Although illustrative embodiments have been described herein with reference to the accompanying drawings, it is to be understood that illustrative embodiments are not limited to those precise embodiments, and that various other changes and modifications are made therein by one skilled in the art without departing from the scope of the appended claims.

What is claimed is:

1. A method of assembling a donor part to a receiver part, comprising:
placing the receiver part on a stage;
providing at least one compliant elastomeric member associated with at least one of the stage and a vacuum element; and
using the vacuum element to lift the donor part and assemble it to the receiver part on the stage, wherein misalignment of the receiver part and the donor part is tolerated by the at least one compliant elastomeric member.

2. The method of claim 1, wherein one compliant elastomeric member is associated with the stage and another compliant elastomeric member is associated with the vacuum element.

3. The assembly of claim 2, wherein the other compliant elastomeric member associated with the vacuum element comprises a pick-tip.

4. The method of claim 3, further comprising:
applying force by moving the pick-tip toward the stage, moving the stage toward the pick-tip, or moving the pick-tip and the stage towards each other.

5. The method of claim 1, wherein the misalignment of the receiver part and the donor part is tolerated by deformation of the at least one compliant elastomeric member.

6. The method of claim 5, wherein the deformation of the at least one compliant elastomeric member is reversible.

7. An assembly comprising:
a donor part;
a receiver part;
a stage supporting the receiver part;
a vacuum element movable with respect to the stage; and
at least one compliant elastomeric member associated with at least one of the stage and the vacuum element; and
wherein the donor part is secured to the vacuum element by vacuum and is located adjacent to the receiver part and wherein misalignment of the receiver part and the donor part is tolerated by the at least one compliant elastomeric member.

8. The assembly of claim 7, wherein one compliant elastomeric member is associated with the stage and another compliant elastomeric member is associated with the vacuum element.

9. The assembly of claim 8, wherein the other compliant elastomeric member associated with the vacuum element comprises a pick-tip.

10. The assembly of claim 9, wherein the pick-tip comprises an elastomer with a Young's modulus of 4 MPa.

11. The assembly of claim 9, wherein the pick-tip comprises a suction cup which is shaped like a hollow rectangular prism.

12. The assembly of claim 9, wherein the pick-tip comprises an elastomer selected from the group consisting of: nitrile rubber, fluoro-elastomer and silicone rubber.

13. The assembly of claim 7, wherein the receiver part comprises a silicon die with embedded V-grooves.

14. The assembly of claim 13, wherein the donor part comprises a glass or polymer lid.

15. The assembly of claim 7, wherein the receiver part comprises a silicon die with an embedded cavity.

16. The assembly of claim 15, wherein the donor part comprises an indium phosphide laser die.

17. An assembly comprising:
a donor part;
a receiver part;
a stage supporting the receiver part;
a vacuum element movable with respect to the stage; and
at least one compliant elastomeric member associated with at least one of the stage and the vacuum element; and
wherein the donor part is secured to the vacuum element by vacuum and is located adjacent to the receiver part, wherein misalignment of the receiver part and the donor part is tolerated by deformation of the at least one compliant elastomeric member, and wherein the deformation of the at least one compliant elastomeric member is reversible.

18. The assembly of claim 17, wherein one compliant elastomeric member is associated with the stage and another compliant elastomeric member is associated with the vacuum element.

19. The assembly of claim 18, wherein the other compliant elastomeric member associated with the vacuum element comprises a pick-tip.

20. The assembly of claim 19, wherein the pick-tip comprises an elastomer selected from the group consisting of: nitrile rubber, fluoro-elastomer and silicone rubber.
